(19) United States
(12) Patent Application Publication
(10) Pub. No.: US 2016/0079713 A1
(43) Pub. Date: Mar. 17, 2016

(54) ELECTRICAL CONNECTOR AND ASSEMBLY THEREOF

(71) Applicant: ALLTOP ELECTRONICS (SUZHOU) LTD., Taicang City (CN)

(72) Inventors: Wang-I YU, Jhonghe City (TW); Mao-Jung HUANG, Jhonghe City (TW)

(73) Assignee: ALLTOP ELECTRONICS (SUZHOU) LTD., Taicang City (CN)

(21) Appl. No.: 14/737,818

(22) Filed: Jun. 12, 2015

(30) Foreign Application Priority Data
Sep. 16, 2014 (CN) 201410470397.0

(51) Int. Cl. H01R 13/6581; H01R 24/60

(52) U.S. Cl. CPC H01R 13/6581; H01R 24/60; H01R 2107/00

(57) ABSTRACT

An electrical connector includes an insulative housing, a number of electrical contacts secured to the insulative housing and a shielding element surrounding the insulative housing and forming a receiving space with the insluative housing. Each electrical contact includes a contact portion, a tail portion extending out of the base, and a retention portion connected with the contact portion and the tail portion. The shielding element includes an outer shell and an inner shell. The inner shell has a number of spring tabs located in the receiving space and the outer shell is provided with a number of yielding spaces for receiving the spring tabs.

### BACKGROUND OF THE INVENTION

1. Field of the Invention

The present invention relates to an electrical connector, and more particularly to an electrical connector and assembly thereof.

2. Description of Related Art

With the development of the Electronics Industry, the transmission speeds of I/O connectors are increased significantly. The higher speed requires a better shielding effect. Generally, an electrical connector assembly includes a receptacle mounted to a printed circuit board and a plug inserted into the receptacle. Either of the receptacle and the plug is provided with metal shells connected with each other to establish a ground circuit for acquiring a good shielding effect. Some receptacles have two metal shells i.e. an inner shell and an outer shell. The inner shell contacts with the metal shell of the plug and the outer shell simultaneously thereby form a grounding circuit. Meantime, it is also desired that the inner shell providing enough retention force for the plug which increase the dimension of the receiving space. Otherwise, the plug cannot mate with the receptacle reliably.

An improved electrical connector that overcomes the above-mentioned problems is desired.

### BRIEF SUMMARY OF THE INVENTION

Accordingly, an object of the present invention is to provide an electrical connector and assembly thereof having an improved shielding effect.

The present invention is directed to an electrical connector comprises an insulative housing having a base and a tongue projecting from the base, a plurality of electrical contacts secured to the insulative housing, and a shielding element surrounding the insulative housing and forming a receiving space with the insluative housing. Each electrical contact includes a contact portion located at the tongue, a tail portion extending out of the base, and a retention portion connected with the contact portion and the tail portion. The shielding element includes an outer shell and an inner shell. The inner shell has a plurality of spring tabs located in the receiving space and the outer shell is provided with a plurality of yielding spaces corresponding to the spring tabs. The yielding spaces receive the spring tabs when the spring tabs move out of the receiving space.

An electrical connector comprises an insulative housing having a base and a tongue projecting from the base in a mating direction, a plurality of electrical contacts secured to the insulative housing, and a shielding element surrounding the insulative housing. Each electrical contact includes a contact portion located at the tongue, a tail portion extending out of the base, and a retention portion connected with the contact portion and the tail portion. The shielding element and the insulative housing form a receiving space. The shielding element includes an outer shell and an inner shell. The inner shell has at least on spring tab located in the receiving space which is capable of moving in a direction perpendicular to the mating direction. The outer shell is provided with at least one yielding space communicating with the receiving space thereby the spring tab projecting therein.

An electrical connector assembly comprising a receptacle and a plug inserted into the receptacle. The receptacle comprises an insulative housing having a base and a tongue projecting from the base, a plurality of electrical contacts secured to the insulative housing, and a shielding element surrounding the insulative housing. Each electrical contact includes a contact portion located at the tongue, a tail portion extending out of the base, and a retention portion connected with the contact portion and the tail portion. The shielding element includes an outer shell and an inner shell. The shielding element and the insulative housing form a receiving space to receive the plug. The inner shell has a plurality of spring tabs located in the receiving space and the outer shell is provided with a plurality of yielding spaces corresponding to the spring tabs respectively. The plug is inserted into the receiving space and pushes the spring tabs to move into the yielding spaces.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector according to the present invention;

FIG. 2 is an exploded view of the electrical connector shown in FIG. 1;

FIG. 3 is a perspective view of the outer shell shown in FIG. 2;

FIG. 4 is a perspective view of the inner shell shown in FIG. 2;

FIG. 5 is a perspective view of the electrical connector with the outer shell detached therefrom;

FIG. 6 is a cross-sectional view of the electrical connector taken along the line 1-1 of FIG. 1;

FIG. 7 is a perspective view of an electrical connector according to a second embodiment of the present invention;

FIG. 8 is a cross-sectional view of the electrical connector taken along the line 2-2 of FIG. 7;

FIG. 9 is a perspective view of an electrical connector according to a third embodiment of the present invention;

FIG. 10 is a cross-sectional view of the electrical connector taken along the line 3-3 of FIG. 9;

FIG. 11 is an assembled view of the electrical connector assembly of the present invention; and

FIG. 12 is a partial exploded view of the plug connector shown in FIG. 11.

### DETAILED DESCRIPTION OF THE PREFERRED EMBODIMENT

Reference will be made to the drawing figures to describe the present invention in detail, wherein depicted elements are not necessarily shown to scale and wherein like of similar elements are designated by same or similar reference numeral through the several views and same or similar terminology.

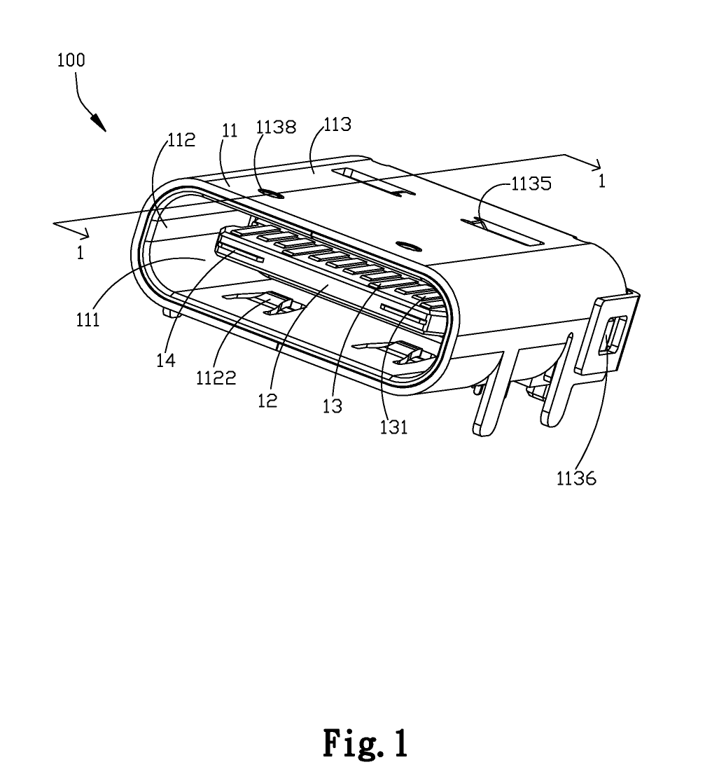

Referring to FIGS. 1 and 11-12, an electrical connector assembly of the present invention includes a receptacle 100 and a plug 200 mating with each other.

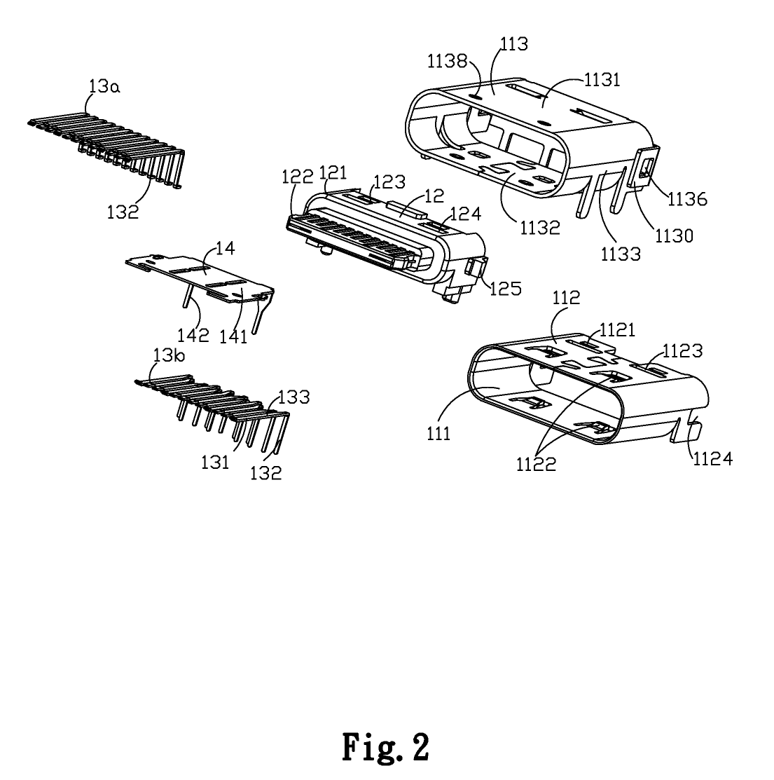

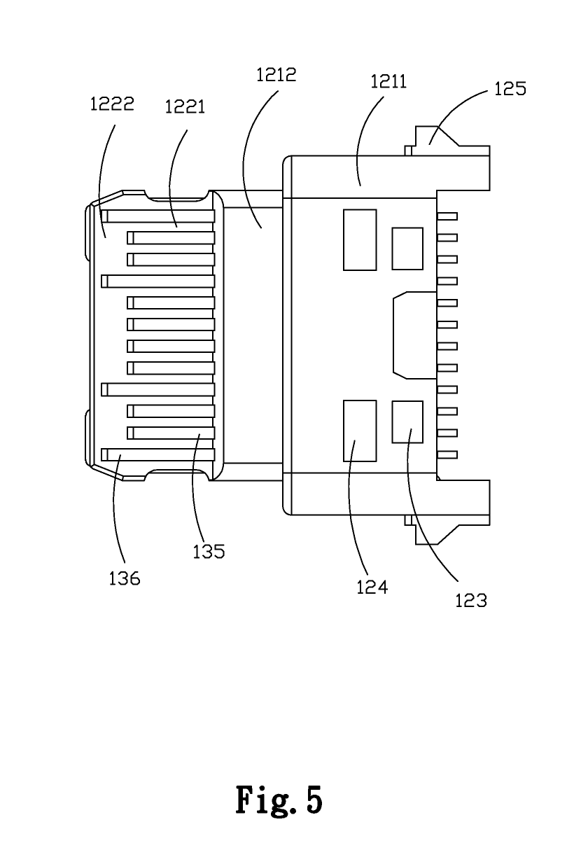

With reference to FIGS. 2 and 5, the receptacle 100 is mounted to a printed circuit board (not shown) and is capable of accommodating the plug 200. The receptacle 100 includes a first housing 12, a plurality of first contacts 13 secured to the first housing 12, a grounding piece 14 attached to the first housing 12, and a first shielding element 11 surrounding the first housing 12. The first housing 12 has a base 121 and a tongue 122 extending forwardly from the base 121. The base 121 has a pair of blocks 125 at opposite sides thereof. A pair of first recesses 123 and a pair of second recesses 124 are provided at a top end of the base 121.

Please refer to FIGS. 2, 5 and 6, the first contacts 13 are arranged in two rows, i.e. an upper row 13a and a lower row 13b which are disposed at opposite sides of the tongue 122. The first contact 13 has a contact portion 131 exposed on the tongue 122, a tail portion 132, and a retention portion 133 located between the contact portion 131 and the tail portion 132. The tail portion 132 projects out of the base 121 for mounting to the printed circuit board.

The upper row 13a and the lower row 13b are inserted molding with two insulative blocks respectively and then together form the first housing 12 via another inserted molding. As an alternative method, the first contacts can be inserted into the first housing directly. In each row of the first contacts 13, there are signal contacts 135 for transmitting signals, grounding contacts 136 located between the signal contacts 135 and power contacts. The grounding contacts 136 are used to reduce the signal interference for the signal contacts 135.

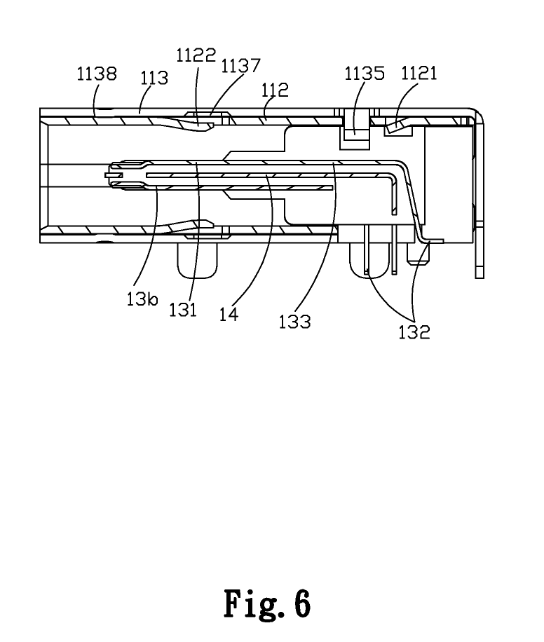

Please referring to FIGS. 2 and 6, the grounding piece 14 includes a main plate 141 and a plurality tails 142 bending downwardly from the main plate 141. The grounding piece could be insert molding with the first housing or inserted into the first housing directly. The main plate 141 extends from the base 121 into the tongue 122 which projects out of a front edge of the tongue 122 and separates the upper row 13a from the lower row 13b thereby providing shielding therebetween.

Please referring to FIG. 2, the first shielding element 11 includes an inner shell 112 and an outer shell 113 surrounding the inner shell 112. The first shielding element 11 and the first housing 12 form a first receiving space 111 for the plug 200. The first receiving space 111 is central symmetry so that the plug 200 can be inserted into the receptacle 100 from either positive or negative directions.

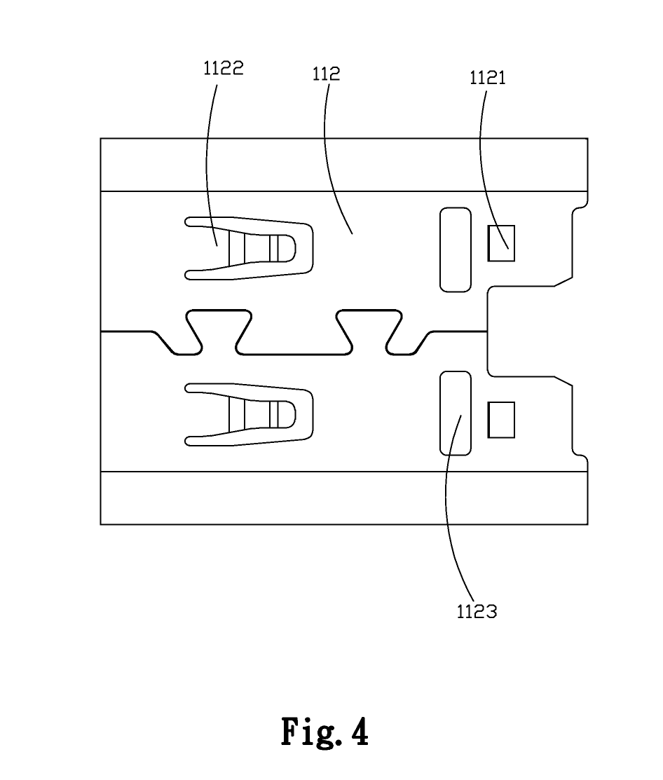

Please refer to FIGS. 2 and 4, the inner shell 112 has a plurality of first spring tabs 1121 at a top wall thereof and projecting into a plurality of first slots 123 defined on the base 121. The inner shell 112 forms a pair of cutouts 1124 at opposite sides thereof. The inner shell 112 is provided with a plurality of second spring tabs 1122 on the top wall and bottom wall thereof. The second spring tabs 1122 connect with a front end of the inner shell 112 and extend backwardly. A free end of the second spring tab 1122 projects into the first receiving space 111 for contacting with the plug 200.

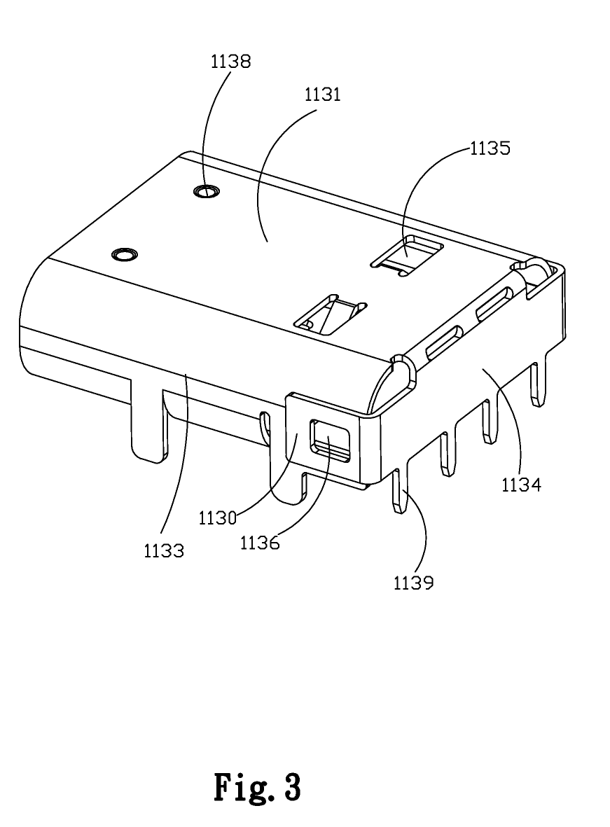

Please refer to FIGS. 2 and 3, the outer shell 113 includes a top wall 1131, a bottom wall 1132, a pair of side walls 1133 connecting with the top wall 1131 and the bottom wall 1132, and a rear wall 1134 bent from the top wall 1131. The top wall 1131 has a pair of third spring tabs 1135 at a rear end thereof. A pair of ear portion 1130 bend from the rear wall 1134 to the side walls 1133 and each defines a third recess 1136 thereon. The top wall 1131 and the bottom wall 1132 both are provided a plurality of protrusions 1138 projecting to the first receiving space 111 for contacting with the inner shell 112. The top wall 1131 and the bottom wall 1132 further defines a plurality of yielding spaces 1137 corresponding to the second spring tabs 1122 of the inner shell 112 and communicating with the first receiving space 111. The rear wall 1134 has a plurality of solder tails 1139 extending downwardly for mounting to the printed circuit board and establishing a grounding circuit between the first shielding element 11 and the printed circuit board.

After the first shielding element 11 mounting to the first housing 12, the first spring tabs 1121 of the inner shell 112 project into the first recesses 123 of the first housing 12. The third spring tabs 1135 of the outer shell 113 extend through a pair of openings 1123 of the inner shell 112 and further clasp the second recesses 124. The pair of blocks 125 of the base 121 engage with the cutouts 1124 and the third recesses 1136. Therefore, the inner shell 112, the outer shell 113 and the first housing 12 are assembled together. The second spring tabs 1122 of the inner shell 112 face the yielding spaces 1137 of the outer shell 121, respectively.

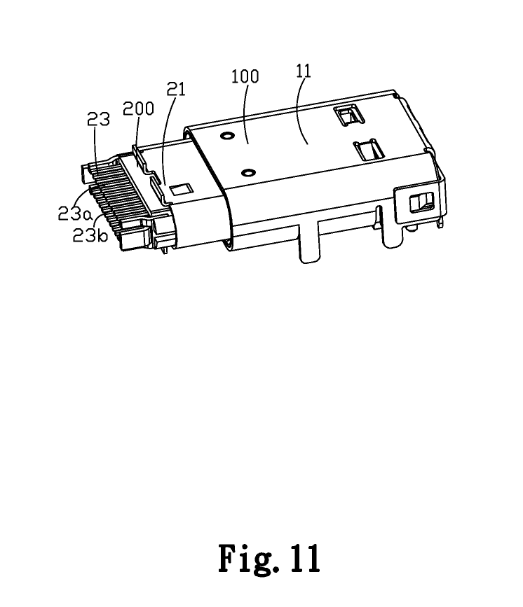

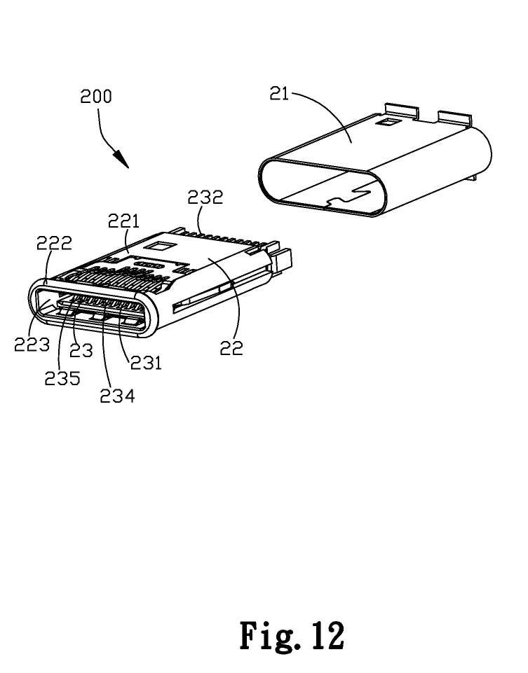

Please referring to FIGS. 11-12, the plug 200 includes a second housing 22, a plurality of second contacts 23 attached to the second housing 22, and a second shielding element 21 surrounding the second housing 22. The second housing 22 has a base 221 and a mating section 222 extending forwardly from the base 221. The mating section 222 defines a second receiving space 223 for receiving the tongue 122 of the receptacle 100.

The second contacts 23 are arranged in two rows, i.e. an upper row 23a and a lower row 23b which are disposed at opposite sides of the second receiving space 223. The second contact 23 has a contact portion 231 projecting into the second receiving space 223, a tail portion 232 extending out of the second housing 22, and a retention portion (not labeled) connected with the contact portion 231 and the tail portion 232. The second contacts 23 are inserted into the second housing 22 directly. As an alternative method, the second contacts also could be inserted molding with the second housing 22. In each row of the second contacts 23, there are signal contacts 234 for transmitting signals or power and grounding contacts 235 located between the signal contacts 234. The grounding contacts 235 are used to reduce the signal interference for the signal contacts 234.

When the plug 200 is inserted into the first receiving space 111 of the receptacle 100 along a mating direction, the tongue 122 is received in the second receiving space 223 of the plug 200. Each first contact 13 contacts with a corresponding second contact 23 for establishing electrical connection. The second shielding element 21 pushes the second spring tabs 1122 of the inner shell 112 moving in a direction perpendicular to the mating direction. Since the outer shell 113 is provided with the yielding spaces 1137, the second spring tabs 1122 move out of the first receiving space 111 and project into the yielding spaces 1137. The yielding spaces 1137 can provide the second spring tabs 1122 a bigger elastic deformation compared to the conventional connectors so that the second spring tabs 1122 has a bigger clamping force for the plug 200. In addition, the yielding spaces 1137 can substitute part of the first receiving spaces 111 which can reduce the thickness of the receptacle 200 and obtain a same clamping force as the conventional connector.

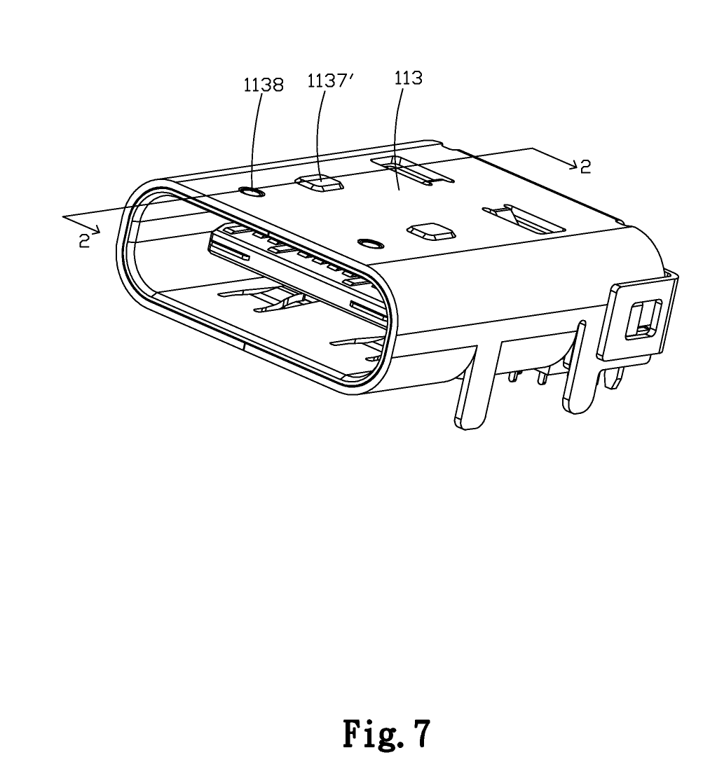

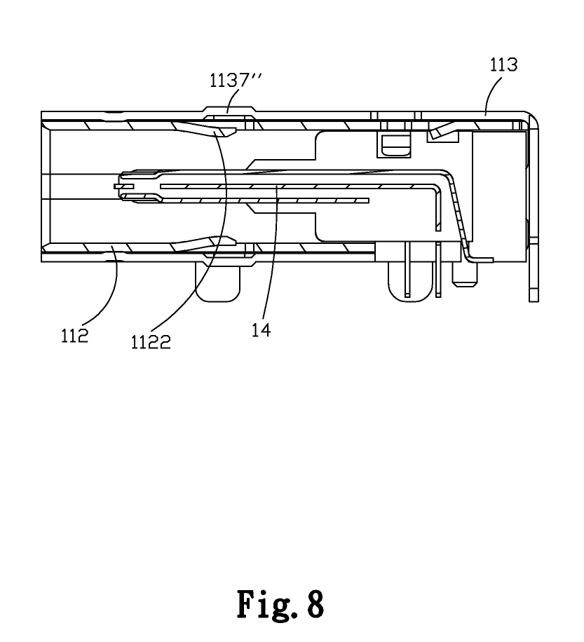

Next referring to FIGS. 7 and 8, description will be made of a receptacle according to a second embodiment which is substantially similar to the receptacle 100 except the yielding spaces 1137′ of the outer shell 113′. Please refer to FIG. 6, the outer shell 113 becomes thin thereby forming the yielding spaces 1137 with an outer surface of the outer shell 113 is flat. However, the yielding spaces 1137′ are formed by a plurality of protrusions projecting beyond the outer surface of the outer shell 113′.

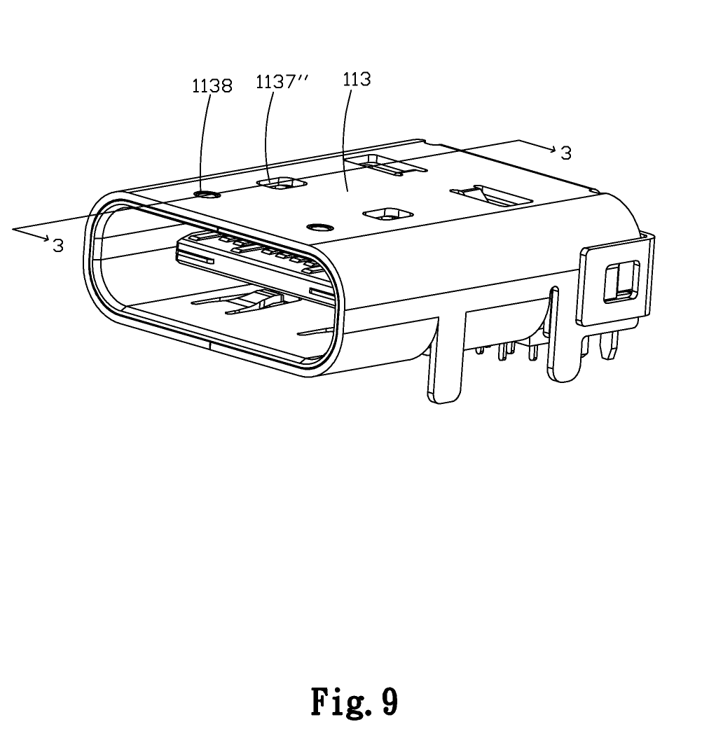

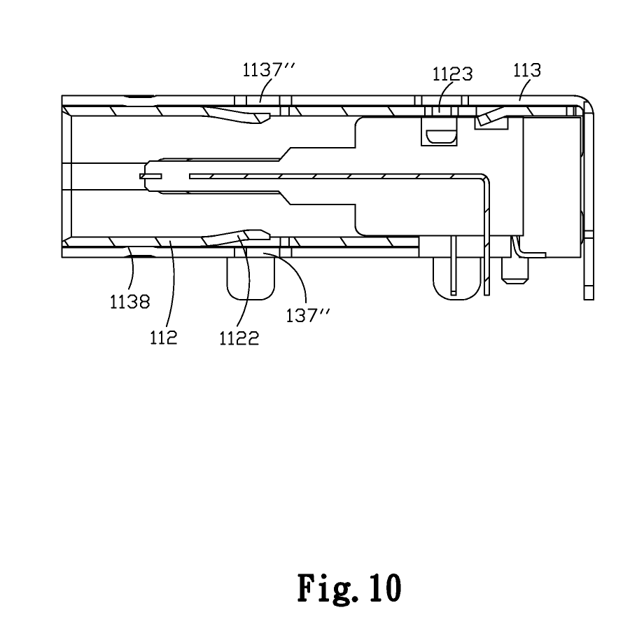

FIGS. 9 and 10 show a receptacle according to a third embodiment of the present invention. The receptacle is substantially similar to the receptacle 100 except the yielding spaces 1137″ of the outer shell 113″. The yielding spaces 1137′ extend through the outer shell 113.

The ground circuit between the first and second shielding elements 11, 21 of the receptacle 100 and the plug 200 is formed by the second shielding element 21, the second spring tabs 1122, the protrusions 1138 of the inner shell 112, the top wall 1131, and the solder tails 1139 of the outer shell 113.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector comprising:
an insulative housing having a base and a tongue projecting from the base;
a plurality of electrical contacts secured to the insulative housing and each including a contact portion located at the tongue, a tail portion extending out of the base, and a retention portion connected with the contact portion and the tail portion; and
a shielding element surrounding the insulative housing and including an outer shell and an inner shell, the shielding element and the insulative housing forming a receiving space;
wherein the inner shell has a plurality of spring tabs located in the receiving space and the outer shell is provided with a plurality of yielding spaces corresponding to the spring tabs, and wherein the yielding spaces are capable of receiving the spring tabs when the spring tabs move out of the receiving space.

2. The electrical connector according to claim 1, wherein the outer shell becomes thin to form the yielding spaces and an outer surface of the outer shell is flat.

3. The electrical connector according to claim 1, wherein the yielding spaces are formed a plurality of protrusions projecting beyond an outer surface of the outer shell.

4. The electrical connector according to claim 1, wherein the yielding spaces extend through the outer shell.

5. The electrical connector according to claim 1, wherein the spring tabs connect with a front end of the inner shell and extend backwardly, and wherein free ends of the spring tabs project into the receiving space.

6. The electrical connector according to claim 1, wherein the inner shell is provided with a plurality of spring tabs projecting into a plurality of recesses defined on the base; and wherein the outer shell is provided with a plurality of spring tabs extending through the inner shell and further clasp the base; and wherein the base has a pair of blocks engaging with a pair of cutouts defined the inner shell and a pair of recesses defined on the outer shell.

7. The electrical connector according to claim 1, wherein the outer shell is provided a plurality of protrusions contacting with the inner shell.

8. An electrical connector comprising:
an insulative housing having a base and a tongue projecting from the base in a mating direction;
a plurality of electrical contacts secured to the insulative housing and each including a contact portion located at the tongue, a tail portion extending out of the base, and a retention portion connected with the contact portion and the tail portion; and
a shielding element surrounding the insulative housing and including an outer shell and an inner shell, the shielding element and the insulative housing forming a receiving space;
wherein the inner shell has at least on spring tab located in the receiving space which is capable of moving in a direction perpendicular to the mating direction, and wherein the outer shell is provide with at least one yielding space communicating with the receiving space thereby the spring tab projecting therein.

9. The electrical connector according to claim 8, wherein the outer shell becomes thin to form the yielding spaces and an outer surface of the outer shell is flat.

10. The electrical connector according to claim 8, wherein the yielding spaces are formed a plurality of protrusions projecting beyond an outer surface of the outer shell.

11. The electrical connector according to claim 8, wherein the yielding spaces extend through the outer shell.

12. The electrical connector according to claim 8, wherein the spring tabs connect with a front end of the inner shell and extend backwardly, and wherein free ends of the spring tabs project into the receiving space.

13. The electrical connector according to claim 8, wherein the inner shell is provided with a plurality of spring tabs projecting into a plurality of recesses defined on the base, and the outer shell is provided with a plurality of spring tabs extending through the inner shell and further clasp a plurality of recesses defined the base, and wherein the base has a pair of blocks engaging with a pair of cutouts defined the inner shell and a pair of recesses defined on the outer shell.

14. The electrical connector according to claim 8, wherein the outer shell is provided a plurality of protrusions contacting with the inner shell.

15. An electrical connector assembly comprising:
a receptacle comprising:
an insulative housing having a base and a tongue projecting from the base;
a plurality of electrical contacts secured to the insulative housing and each including a contact portion located at the tongue, a tail portion extending out of the base, and a retention portion connected with the contact portion and the tail portion; and
a shielding element surrounding the insulative housing and including an outer shell and an inner shell, the shielding element and the insulative housing forming a receiving space, the inner shell has a plurality of spring tabs located in the receiving space and the outer shell is provided with a plurality of yielding spaces corresponding to the spring tabs respectively; and
a plug inserted into the receiving space of the receptacle and pushing the spring tabs to move into the yielding spaces.

16. The electrical connector assembly according to claim 15, wherein the yielding space are covered by the outer shell and separated from an exterior of the electrical connector.

17. The electrical connector assembly according to claim 15, wherein the yielding spaces extend through the outer shell and communicated with an exterior of the electrical connector.

18. The electrical connector assembly according to claim 15, wherein the base has a pair of blocks engaging with a pair of cutouts defined the inner shell and a pair of recesses defined on the outer shell.

19. The electrical connector assembly according to claim 15, wherein both the inner shell and the outer shell are provided with a plurality of spring tabs clamping a plurality of recesses defined on the base.

20. The electrical connector assembly according to claim 15, wherein the outer shell is provided a plurality of protrusions contacting with the inner shell.
